(19) United States
(12) Patent Application Publication
(10) Pub. No.: US 2026/0284934 A1
(43) Pub. Date: Sep. 24, 2026

(54) Platform for Supporting a Slab During Computer-Controlled or Automated Cutting

(71) Applicant: Vangura Kitchen Tops, Inc., North Huntingdon, PA (US)

(72) Inventor: Edward P. Vangura, North Huntingdon, PA (US)

(21) Appl. No.: 19/313,041

(22) Filed: Aug. 28, 2025

Related U.S. Application Data
(60) Provisional application No. 63/687,934, filed on Aug. 28, 2024.

(51) Int. Cl. B28D 7/04; B28D 7/00

(52) U.S. Cl. CPC B28D 7/046; B28D 7/005

(57) ABSTRACT

A platform for supporting a slab during automated cutting includes a frame for supporting the slab in a substantially horizontal position over a cutting bed. The frame includes multiple rails configured to extend over the bed and pneumatic pistons mounted to the rails and arranged to form a grid arranged in rows and columns of pneumatic pistons for supporting the slab over the cutting bed. The platform also includes at least one pneumatic source fluidly connected to the pneumatic pistons that selectively causes one or more of the pneumatic pistons to extend and retract and a controller. The controller is configured to selectively apply fluid pressure from the at least one pneumatic source to the one or more of the pneumatic pistons for extending or retracting the pneumatic pistons in coordination with automated cutting of the slab.

### CROSS REFERENCE TO RELATED APPLICATION

The present application claims the benefit of United States Provisional Patent Application No. 63/687,934, filed Aug. 28, 2024, the disclosure of which is hereby incorporated by reference in its entirety.

### BACKGROUND OF THE INVENTION

### Field of the Invention

The invention relates generally to frames, shelves, lifts, or platforms for supporting heavy objects, such as stone slabs, during computer-controlled or automated cutting and, in particular, to a platform device or assembly including a grid of pneumatic pistons configured to be extended and retracted in a coordinated manner to support the object during automated cutting.

### Description of Related Art

Countertops for kitchens, bars, workspaces, desks, bathrooms, and other interior locations can be made from a variety of natural and synthetic materials, including natural stone, engineered stone and other synthetic solid surface materials, and laminated constructions. Luxury and high-end installations often use natural stones, such as granite or marble, as such materials are believed to be more durable and aesthetically pleasing than manmade alternatives. Countertops formed from synthetic solid surface materials (also referred to as manufactured or engineered stone), such as Corian® manufactured by E.I. DuPont, are also available at similar high-end price points. Solid surface materials are synthetic composite materials formed from a combination of natural stone dust (e.g., marble dust), acrylic polymers, epoxy or polyester resins, and similar materials. Solid surface materials can be used to produce a seamless countertop. For example, Corian® is a solid surface material formed from a cured mixture of acrylic polymer and alumina derived from, for example, bauxite ore.

Natural and engineered stone can be cut, molded, and carved with a variety of ornate edge shapes desired by consumers from slabs of various sizes. For example, stone slabs can be about 5 ft. to 10 ft. in length and/or width and weigh about 10 to 20 pounds per square foot. An average slab can have a total weight of between about 500 lbs. and 1,000 lbs. depending upon the thickness of the slab type of stone material. Cutting is often performed using computer controlled cutting machinery, as is known in the art. The computer-controlled machinery is capable of cutting the slab into pieces of a predetermined sizes and shapes, as well for cutting openings or holes in the slabs for sinks, faucets, stoves, and other appliances. The computer-controlled machinery is also capable of cutting complex curved edge profiles on edges of the countertop.

Currently available cutting machines generally include a flat bed or surface, with the cutting machinery supported above the surface on a movable track or mechanical arm. In some cases, the slab can be supported on the bed or surface by various posts, extendable members, stops, and other supporting devices. In most cases, individual supporting devices are positioned manually by a user prior to moving the slab onto the bed or surface. The process of individually positioning multiple supporting devices prior to use can be tedious and cumbersome. Therefore, there is a need in the art for more robust supporting devices or platforms for stone slabs that eliminate the need for manually positioning the supporting devices prior to use. The platforms and methods of the present disclosures are provided to address these issues.

### SUMMARY OF THE INVENTION

According to an aspect of the disclosure, a platform for supporting a slab during automated cutting includes a frame for supporting the slab in a substantially horizontal position over a cutting bed, the frame comprising a plurality of rails configured to extend over the cutting bed and a plurality of pneumatic pistons mounted to the plurality of rails and arranged to form a grid arranged in rows and columns of pneumatic pistons for supporting the slab over the cutting bed. The platform also includes at least one pneumatic source fluidly connected to the plurality of pneumatic pistons that selectively causes one or more of the plurality of pneumatic pistons to extend and retract and a controller. The controller is configured to selectively apply fluid pressure from the at least one pneumatic source to the one or more of the plurality of pneumatic pistons for extending or retracting the plurality of pneumatic pistons in coordination with automated cutting of the slab.

According to another aspect of the disclosure, a computer-controlled system for automated cutting of a stone slab includes a cutting bed; a computer-controlled cutting machine over the cutting bed configured for cutting the stone slab to a desired shape; and the previously described platform, which is positioned on the cutting bed for supporting the stone slab during cutting. The computer-controlled system also includes a system controller in communication with the computer-controlled cutting machine and with the controller of the platform for coordinating extension and retraction of the plurality of pneumatic pistons of the platform and cutting actions of the computer-controlled cutting machine.

According to another aspect of the disclosure, a method of cutting a stone slab includes the following steps: moving some or all of the plurality of pneumatic pistons of the previously described platform to a same height and moving the slab over some or all of the plurality of pneumatic pistons to a desired position on the grid formed by the plurality of pneumatic pistons. The method further includes, with the slab in place at the desired position, applying suction against a bottom surface of the slab through nozzles of some or all of the plurality of retractable piston devices, and cutting portions of the slab using an automated cutting machine according to a predetermined cutting pattern.

Non-limiting examples of the present invention will now be described in the following numbered clauses:
Clause 1: A platform for supporting a slab during automated cutting, the platform comprising: a frame for supporting the slab in a substantially horizontal position over a cutting bed, the frame comprising a plurality of rails configured to extend over the cutting bed; a plurality of pneumatic pistons mounted to the plurality of rails and arranged to form a grid arranged in rows and columns of pneumatic pistons for supporting the slab over the cutting bed; at least one pneumatic source fluidly connected to the plurality of pneumatic pistons that selectively causes one or more of the plurality of pneumatic pistons to extend and retract; and a controller configured to selectively apply fluid pressure from the at least one pneumatic source to the one or more of the plurality of pneumatic pistons for extending or retracting the plurality of pneumatic pistons in coordination with automated cutting of the slab.
Clause 2: The platform of clause 1, wherein the slab comprises a stone slab (e.g., granite, marble, or quartz) with a height and width of about 5 feet to about 10 feet.
Clause 3: The platform of clause 1 or clause 2, wherein the stone slabs weighs about 10 to 20 pounds per square foot with a total weight of 500 pounds to 1000 pounds.
Clause 4: The platform of any of clauses 1-3, further comprising one or more elongated base supports configured to extend over the cutting bed and below the plurality of rails, wherein the plurality of rails are fixed to the one or more elongated base supports for maintaining positioning of the plurality of rails and the plurality of pneumatic pistons on the cutting bed.
Clause 5: The platform of clause 4, wherein the one or more elongated base supports comprises a first support on a first side of the cutting bed and a second support on a second side of the cutting bed, and wherein the plurality of rails extend transversely between the first support and the second support over the cutting bed.
Clause 6: The platform of clause 5, wherein the plurality of rails is equidistantly spaced or substantially equidistantly spaced apart from one another along the first support and the second support.
Clause 7: The platform of any of clauses 1-6, wherein the frame comprises about 5 rails to about 20 rails, preferably about 10 rails to about 15 rails, or more preferably about 12 rails.
Clause 8: The platform of any of clauses 1-7, wherein an equal number of the plurality of pneumatic pistons are attached to each of the plurality of rails, and wherein the plurality of pneumatic pistons are substantially equidistantly spaced apart from one another on each of the plurality of rails.
Clause 9: The platform of any of clauses 1-8, wherein the plurality of pneumatic pistons are mounted to the plurality of rails and arranged to form about 5 rows to 15 rows of pistons, preferably about 7 rows to about 12 rows of the pistons, or more preferably about 10 rows of the pistons.
Clause 10: The platform of any of clauses 1-9, wherein the frame is about 100 inches to about 150 inches in length, preferably about 130 inches to about 140 inches in length, or more preferably about 137 inches in length, and about 25 inches to about 100 inches in width, preferably about 35 inches to about 80 inches in width, or more preferably about 67 inches in width.
Clause 11: The platform of any of clauses 1-10, wherein the frame comprises about twelve (12) rails and the plurality of pneumatic pistons are arranged to form ten (10) rows, thereby providing a grid of thirteen (13) columns and ten (10) rows of the pneumatic pistons.
Clause 12: The platform of clause 11, wherein the controller is configured to independently extend and retract each of the piston devices arranged in the 10×13 grid.
Clause 13: The platform of any of clauses 1-12, wherein at least one rail of the plurality of rails comprises a track extending longitudinally on a top surface of the at least one rail and rotatable wheels mounted in the track for sliding the slab over the plurality of pneumatic pistons when the plurality of pneumatic pistons are retracted.
Clause 14: The platform of any of clauses 1-13, wherein one or more pistons of the plurality of pneumatic pistons comprises: a base mounted to one or more of the plurality of rails of the frame; a piston member at least partially disposed within the base; and a pneumatic actuator for extending and retracting the piston member.
Clause 15: The platform of clause 14, wherein the actuator of the one or more pistons receives pressurized fluid form the at least one pneumatic source to extend and retract the one or more pistons.
Clause 16: The platform of clause 14 or clause 15, wherein the one or more pistons further comprises a cover over a distal end of the piston member configured to contact and support a bottom surface of the slab.
Clause 17: The platform of clause 16, wherein the one or more pistons comprises at least one nozzle extending through the cover configured for applying suction for holding the slab against the cover.
Clause 18: The platform of any of clauses 15-17, wherein the at least one nozzle is further configured for applying positive pressure against the bottom surface of the slab to enable sliding of the slab over the cover of the one or more pistons.
Clause 19: The platform of clause 18, wherein the at least one nozzle is a suction nozzle configured to apply suction for holding the slab against the cover, the one or more pistons further comprising a separate nozzle for applying positive pressure to the bottom surface of the slab for separating the bottom surface of the slab from the cover.
Clause 20: The platform of any of clauses 1-19, wherein the one or more pistons further comprises a mechanical lock for holding the piston member in an extended position when application of pressure to the one or more pistons ceases.
Clause 21: The platform of any of clauses 1-20, wherein the at least one pneumatic source comprises a fan or blower.
Clause 22: The platform of any of clauses 1-21, wherein the at least one pneumatic source comprises a negative pressure source for applying suction against a bottom surface of the slab and a positive pressure source for extending the plurality of pneumatic pistons and for lifting the slab off of a cover of the plurality of pneumatic pistons for sliding the slab over the plurality of pneumatic pistons.
Clause 23: The platform of clause 22, wherein the negative pressure source is further configured to retract the plurality of pneumatic pistons.
Clause 24: The platform of any of clause 22 or clause 23, wherein the one or more of the plurality of pneumatic pistons comprises at least one positive pressure port that receives positive pressure from the at least one pneumatic source for extending the one or more pistons and at least one negative pressure port that receives negative pressure from the at least one pneumatic source for applying suction to the bottom surface of the slab.
Clause 25: The platform of clause 24, wherein the at least one negative pressure port comprises a suction port that receives negative pressure from the at least one pneumatic source for applying suction to the bottom surface of the slab and a retraction port that receives negative pressure from the at least one pneumatic source for applying negative pressure to retract the one or more pistons.
Clause 26: The platform of clause 24 or clause 25, further comprising cables extending from each of the at least one positive pressure port and the at least one negative pressure port of the one or more pistons to the pneumatic source.
Clause 27: The platform of any of clauses 22-26, wherein the controller is configured to selectively cause the negative pressure source to apply suction against the bottom of the slab through one or more pistons of the plurality of pneumatic pistons by actuating one or more pneumatic valves.
Clause 28: The platform of clause 27, wherein the one or more pneumatic valves are fluidly connected between the negative pressure source and the one or more pistons, such that when the one or more pneumatic valves are opened, the suction is applied against the bottom of the slab and when the one or more pneumatic valves are closed, application of suction ceases.
Clause 29: The platform of clause 27 or clause 28, wherein the one or more pneumatic valves are fluidly connected to the controller and wherein the controller selectively releases a fluid burst to the one or more pneumatic valves causing the one or more pneumatic valves to open or close.
Clause 30: The platform of clause 29, further comprising a manifold supporting one or more pneumatic valves for each of the plurality of pneumatic pistons.
Clause 31: The platform of clause 30, further comprising cables extending between the one or more pneumatic valves and the plurality of pneumatic pistons for applying the suction against the bottom surface of the slab when the one or more pneumatic valves are open.
Clause 32: The platform of clause 30 or clause 31, wherein the valve manifold comprises 130 pneumatic valves and the platform comprises 130 pneumatic pistons.
Clause 33: The platform of any of clauses 1-32, further comprising at least one retractable stop positioned at a periphery of the grid of the plurality of pneumatic pistons, the at least one retractable stop configured to move between a retracted position allowing the slab to slide over the at least one retractable stop and onto the plurality of pneumatic pistons and an extended position where an edge of the slab contacts the at least one retractable stop for positioning the slab on the grid formed by the plurality of pneumatic pistons.
Clause 34: The platform of clause 33, wherein when extended, the at least one retractable stop is a greater vertical distance above the cutting bed than are top surfaces of the plurality of pneumatic pistons.
Clause 35: The platform of clause 33 or clause 34, wherein the at least one retractable stop comprises transverse stops that are transverse to the plurality of rails and parallel stops that are parallel to the plurality of rails.
Clause 36: The platform of any of clauses 1-35, wherein the controller comprises a user terminal comprising input buttons, a touch screen display, and/or a user interface allowing a user to selectively extend and retract one or more pistons of the plurality of pneumatic pistons.
Clause 37: A computer-controlled system for automated cutting of a stone slab, comprising: a cutting bed; a computer-controlled cutting machine over the cutting bed configured for cutting the stone slab to a desired shape; the platform of any of clauses 1-36 positioned on the cutting bed for supporting the stone slab during cutting; and a system controller in communication with the computer-controlled cutting machine and with the controller of the platform for coordinating extension and retraction of the plurality of pneumatic pistons of the platform and cutting actions of the computer-controlled cutting machine.
Clause 38: A method of cutting a stone slab, comprising: moving some or all of the plurality of pneumatic pistons of the platform of any of clauses 1-36 to a same height; moving the slab over some or all of the plurality of pneumatic pistons to a desired position on the grid formed by the plurality of pneumatic pistons; with the slab in place at the desired position, applying suction against a bottom surface of the slab through nozzles of some or all of the plurality of retractable piston devices; and cutting portions of the slab using an automated cutting machine according to a predetermined cutting pattern.
Clause 39: The method of clause 38, wherein moving the slab over some or all of the plurality of pneumatic pistons comprises causing positive pressure from the pneumatic source to be expelled from nozzles of some or all of the plurality of pneumatic pistons allowing the slab to slide over top surfaces of the plurality of pneumatic pistons.
Clause 40: The method of clause 38 or clause 39, further comprising, after cutting is performed, retracting some of the plurality of pneumatic pistons to recess discardable portions of the slab and, after discardable portions of the slab are recessed, sliding a remaining usable portion of the slab off of the platform.

### BRIEF DESCRIPTION OF THE DRAWINGS

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limit of the invention.

FIG. 1A is a perspective view of an automated cutting system including a CNC machine and platform, according to an aspect of the present disclosure;

FIG. 1B is a schematic drawing of a top view of the platform of FIG. 1A showing a grid of pistons mounted to a frame, according to an aspect of the present disclosure;

FIGS. 2A and 2B are additional perspective views of the automated cutting system of FIG. 1A with some pistons of the platform in an extended position and other pistons of the platform in a retracted position;

FIG. 3A is a schematic drawing of a piston in a retracted position, according to an aspect of the present disclosure;

FIG. 3B is a schematic drawing of the piston of FIG. 3A in an extended position;

FIGS. 4A and 4B are schematic drawings showing electrical and pneumatic components of the piston of FIG. 3A according to an aspect of the present disclosure;

FIG. 5A is a schematic drawing showing electrical and pneumatic components of the platform of FIGS. 1A and 1B, according to an aspect of the present disclosure;

FIG. 5B is a schematic drawing of a manifold and pneumatic valves of the platform of FIGS. 1A and 1B for applying suction to a bottom surface of a slab, according to an aspect of the present disclosure;

FIGS. 6A-6C are screen captures showing a user interface displayed on a user terminal of the platform for controlling extension and retraction of the pneumatic pistons, according to an aspect of the present disclosure;

FIG. 7 is a schematic drawing of a computer-controlled system for automated cutting of a stone slab, according to an aspect of the present disclosure;

FIG. 8 is a flow chart illustrating a method for cutting a stone slab, according to an aspect of the present disclosure;

FIGS. 9A and 9B are perspective views showing an operator placing a stone slab on the platform in order to cut the slab using the automated cutting system, according to aspect of the present disclosure;

FIG. 10A is schematic drawing of a platform with the pneumatic pistons in an extended position;

FIG. 10B is a schematic drawing of the platform of FIG. 10A and a slab with some of the pistons retracted to facilitate cutting an opening in the slab; and

FIG. 10C is a schematic drawing of the platform of FIG. 10A, with additional pistons retracted to lower discardable portions of the slab.

### DETAILED DESCRIPTION

As used herein, the singular form of “a”, “an”, and “the” include plural referents unless the context clearly dictates otherwise. For the purposes of this specification, unless otherwise indicated, all numbers expressing quantities of ingredients, reaction conditions, dimensions, physical characteristics, and so forth used in the specification and claims are to be understood as being modified in all instances by the term “about.”

As used herein, the terms “right”, “left”, “top”, and derivatives thereof shall relate to the invention as it is oriented in the drawing figures. However, it is to be understood that the invention can assume various alternative orientations and, accordingly, such terms are not to be considered as limiting. Also, it is to be understood that the invention can assume various alternative variations and stage sequences, except where expressly specified to the contrary. It is also to be understood that the specific devices and processes illustrated in the attached drawings, and described in the following specification, are examples. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all sub-ranges beginning with a minimum value equal to or greater than 1 and ending with a maximum value equal to or less than 10, and all sub-ranges in-between, e.g., 1 to 6.3, or 5.5 to 10, or 2.7 to 6.1.

The present disclosure is directed to a framework, lift, support, or platform 10 for raising, lowering, and/or supporting a slab 2 during automated cutting, such as cutting by a computer-controlled device (e.g., a computer numerical control (CNC) machine). As used herein, a “slab” can refer to a heavy object comprising opposing planar surfaces or sides with a narrow peripheral edge extending between the planar surfaces. The slab 2 can comprise a variety of natural and/or synthetic materials, such as natural stone, engineered stone, concrete, various epoxy constructs, and/or other manufactured materials. A conventional slab 2 is generally about 5 feet to about 10 feet in length and/or width and weighs from about 500 pounds to about 1,000 pounds.

In examples, the platform 10 is configured for use with a CNC machine 72 that cuts the slab 2 under water by, for example, providing a slurry stream consisting of water and abrasive material against surfaces of the slab 2. The slurry stream creates precise cuts through the slab 2 according to a predetermined cutting pattern or shape. However, the slurry formed by the water and abrasive material can damage devices and mechanical components positioned on a cutting bed 74 of the CNC machine 72. Therefore, the platform 10 of the present disclosure is designed to be durable with few moving parts and/or moving parts that move in only one direction (e.g., up and down) and which do not include complex gears, interlocking components, movable components, locks, latches, or other mechanical features that may be damaged by the slurry.

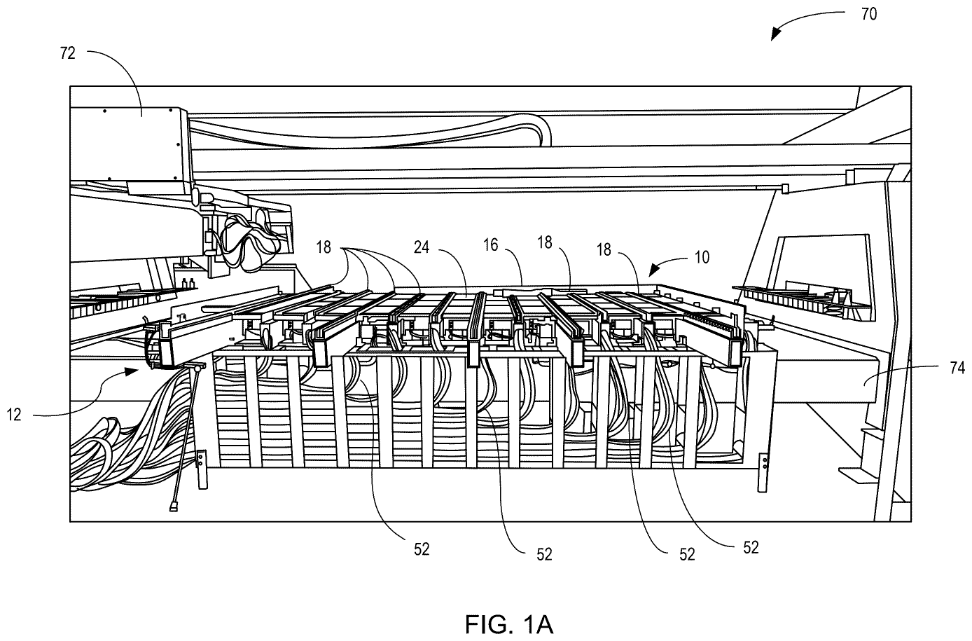

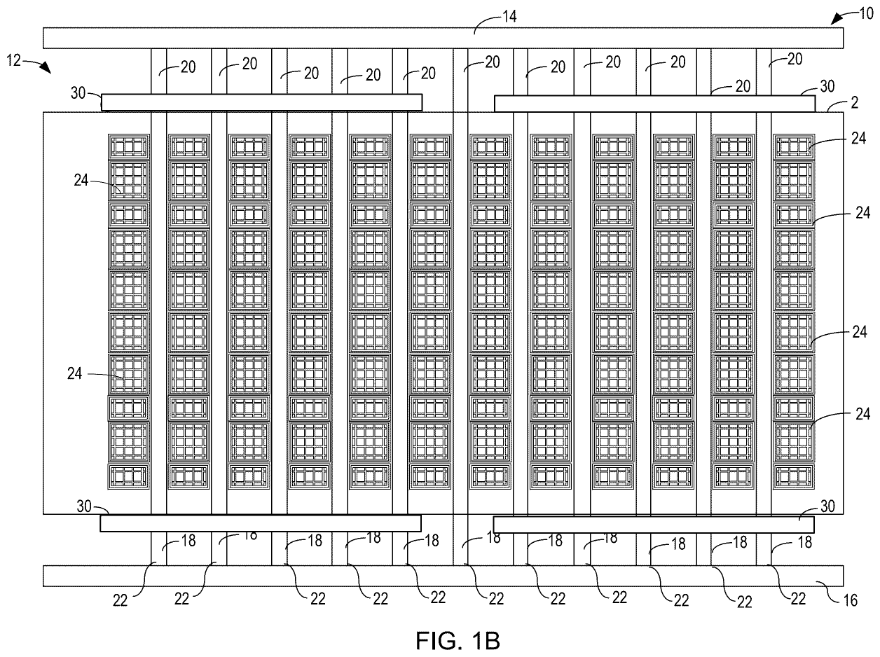

FIG. 1A is a perspective view showing components of an automated cutting system 70 including the platform 10 for supporting a slab 2 (not shown in FIG. 1A) and CNC machine 72 positioned over the platform 10. FIG. 1B is a schematic drawing of the platform 10 showing pneumatic pistons 24 arranged in rows and columns for supporting the slab 2. As shown in FIGS. 1A and 1B, the platform 10 comprises a frame 12 configured to be positioned on a cutting bed 74 (e.g., a bed of the CNC machine 72) for supporting the slab 2 in a horizontal or substantially horizontal (e.g., within 10% of horizontal) position. The frame 12 can be about 100 inches to about 150 inches in length, preferably about 130 inches to about 140 inches in length, or more preferably 137 inches in length, and about 25 inches to 100 inches in width, preferably about 50 inches to about 80 inches in width, or more preferably about 67 inches in width. In examples, the frame 12 is sized to support a slab 2 of a conventional size, such as a 10 ft. (120 inch) by 5 ft. (60 inch) stone slab 2.

In some examples, the frame 12 comprises elongated base members or base supports, such as a front or first base member 14 on one side of the platform 10 and a rear or second base member 16 on an opposite side of the platform 10. The base members 14, 16 can be, for example, metal beams (e.g., beams having an I-shaped cross-section) with a flat bottom surface for resting on the cutting bed 74 of the CNC machine 72. The base members 14, 16 or beams are generally long enough to support a conventional sized stone slab used for countertop manufacturing and/or other interior construction projects. For example, base members 14, 16 or beams can be about 100 inches to about 150 inches in length.

The frame 12 also comprises rails 18 extending over the cutting bed 74. For example, as shown in FIGS. 1A and 1B, the rails 18 can extend over the cutting bed 74 between the first or upper base member 14 and the second or lower base member 16. The rails 18 can be metal bars or beams that are about 25 inches to about 100 inches in length. In some examples, the frame 12 comprises from about five rails to about twenty rails, preferably about ten rails to about fifteen rails, or more preferably twelve rails. The rails 18 can include a first or front end 20 mounted to the first base member 14 and a second or rear end 22 mounted to the second base member 16. In some examples, the ends 20, 22 of the rails 18 can be fixedly mounted to a top surface of the base members 14, 16 or beams by screws, bolts, and/or other mechanical fasteners as are known in the art. Also, as shown in FIG. 1B, the rails 18 can be positioned such that longitudinal axes of the first base member 14 and the second base member 16 are transverse or substantially transverse (e.g., within about 10 degrees of transverse) to longitudinal axes of the rails 18.

In some examples, the rails 18 are equidistantly spaced or substantially equidistantly spaced (e.g., less than a 10% difference in spacing between the rails 18) along the base members 14, 16. For example, a distance between adjacent rails 18 can be about 10 inches to about 15 inches or preferably about 12 inches between rails 18.

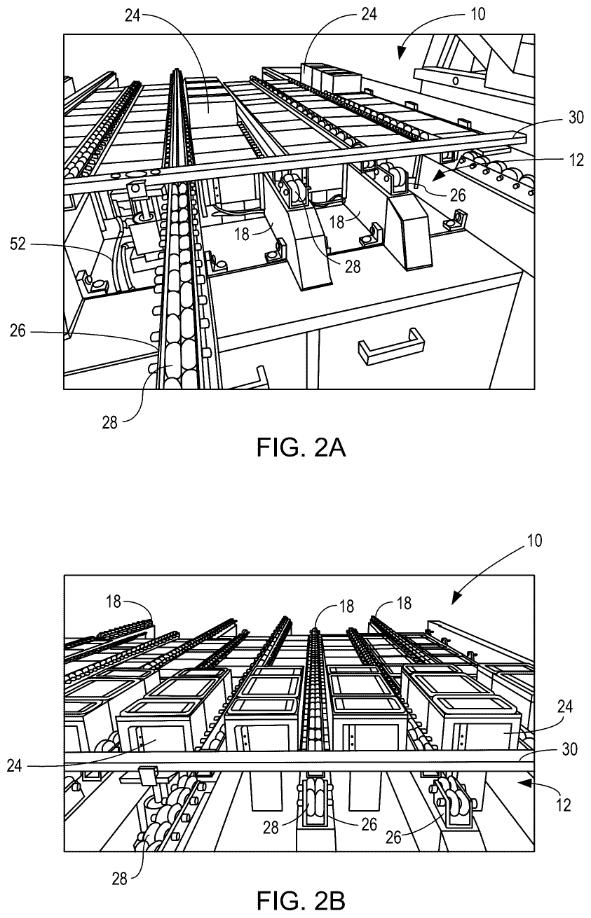

In examples, as shown most clearly in FIGS. 2A and 2B, the rails 18 can comprise or define a track 26 or groove extending longitudinally on a top surface of the rails 18 and rotatable wheels 28 mounted in the track 26. For example, as shown in FIGS. 2A and 2B, each rail 18 can comprise pairs of wheels 28 positioned side-by-side in the track 26 and connected to a common axle. There are multiple pairs of wheels 28 in each track 26 aligned axially over the top surface of the rail 18 and extending nearly an entire length of the rail 18. The wheels 28 are positioned for sliding the slab 2 over the top surfaces of the rails 18 and into position on the cutting bed 74.

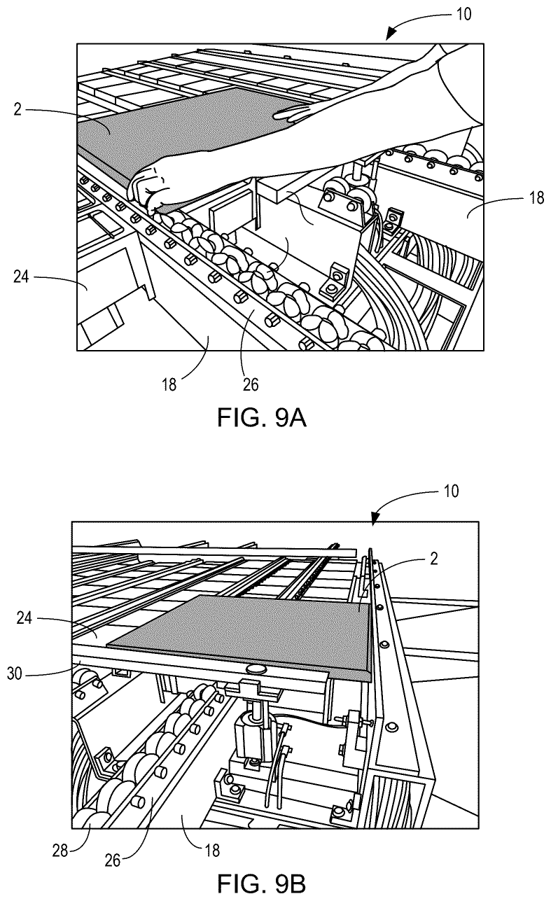

As shown in FIGS. 1A-2B, the platform 10 further comprises the retractable pneumatic devices, modules, pods, or pneumatic pistons 24 mounted to the rails 18. The pneumatic pistons 24 are arranged to form a grid with rows and columns of pneumatic pistons 24 for supporting the slab 2, as shown most clearly in FIG. 1B. In some examples, the platform 10 further comprises retractable stops 30 mounted or positioned along a periphery of the grid of pneumatic pistons 24. For example, as shown in FIG. 1B, the platform 10 comprises two retractable stops 30 along both a first longitudinal side and an opposing second longitudinal side of the grid. Alternatively or in addition, stops 30 can be positioned along latitudinal sides of the grid for preventing the slab 2 from sliding off of the latitudinal sides and for positioning the slab 2 at a zero position (e.g., zeroed in both the longitudinal and latitudinal directions) as shown in FIGS. 9A and 9B. In particular, the slab 2 shown in FIGS. 9A and 9B is positioned against both longitudinal and latitudinal stops 30, so that the position of the slab 2 on the cutting bed 74 is precisely known. Once the precise position of the slab 2 is known, the information can be entered into the CNC machine 72 and used to determine where cuts should be made to complete a selected cutting pattern.

In examples, retractable stops 30 can be mounted to the base members 14, 16 and/or to outermost rails 18 of the platform 10. The stops 30 are configured to move between a retracted position allowing the slab 2 to slide over the stop 30 and onto the pneumatic pistons 24 and an extended position where an edge(s) of the slab 2 contacts the stop 30 for positioning the slab 2 on the grid of the pneumatic pistons 24. In some examples, the stops 30 are configured to flip or pivot upwards when moving from the retracted position to the extended position. In other examples, the stops 30 may simply move vertically between the retracted position and the extended position, such that, in the extended position, the stop 30 are at a greater vertical distance above the cutting bed 74 than are top surfaces of the plurality of pneumatic pistons 24. In examples, the stops 30 can be moved from retracted to extended positions pneumatically by air or fluid from a pneumatic source. In other examples, the stops 30 can be moved manually or by another automated component such as an electric motor or another actuator mechanism.

In some examples, there are an equal number of pneumatic pistons 24 attached to each of the rails 18 forming the grid of pneumatic pistons 24. Also, the pneumatic pistons 24 can be equidistantly or substantially equidistantly (e.g., less than a 10% difference in spacing) spaced apart from one another along each of the rails 18. In some examples, the pneumatic pistons 24 can be arranged to form about five rows to fifteen rows of pneumatic pistons 24, preferably about seven rows to about twelve rows of pistons 24, or more preferably about ten rows of pistons 24. Similarly, the platform 10 can be arranged with about ten to twenty columns, preferably twelve to fifteen columns, and more preferably thirteen columns of pneumatic pistons 24. Therefore, the platform 10 comprises about one hundred (100) to one hundred fifty (150) pneumatic pistons 24 or, as shown in FIG. 1B, preferably, one hundred and thirty (130) pneumatic pistons 24. As previously described, the pneumatic pistons 24 can be arranged to support a 5 foot by 10 foot slab 2 weighing about 500 lbs. to about 1,000 lbs.

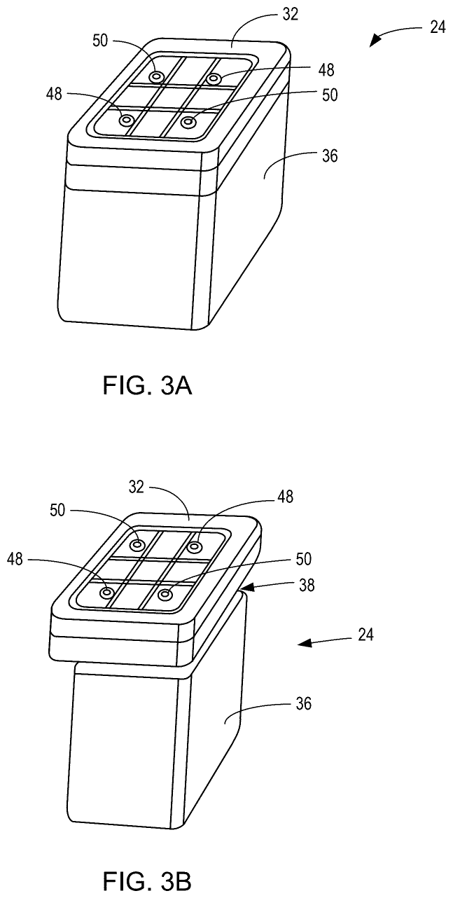

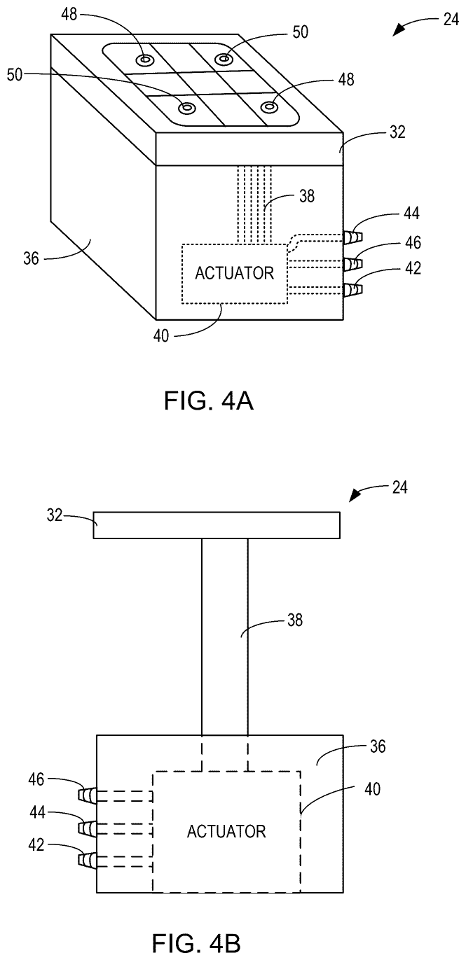

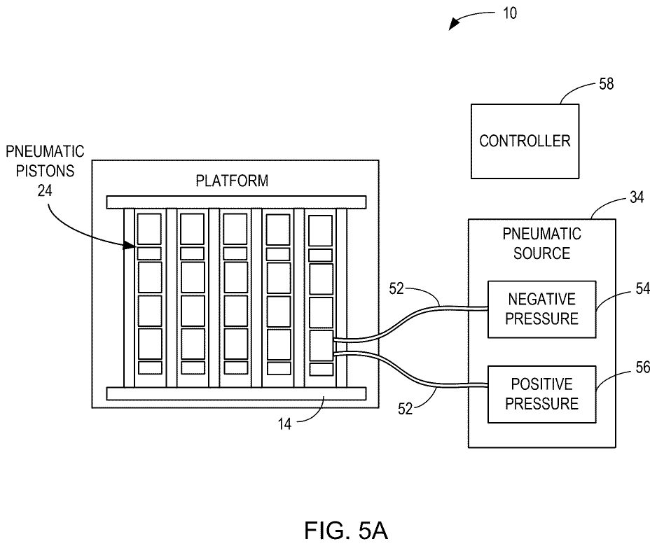

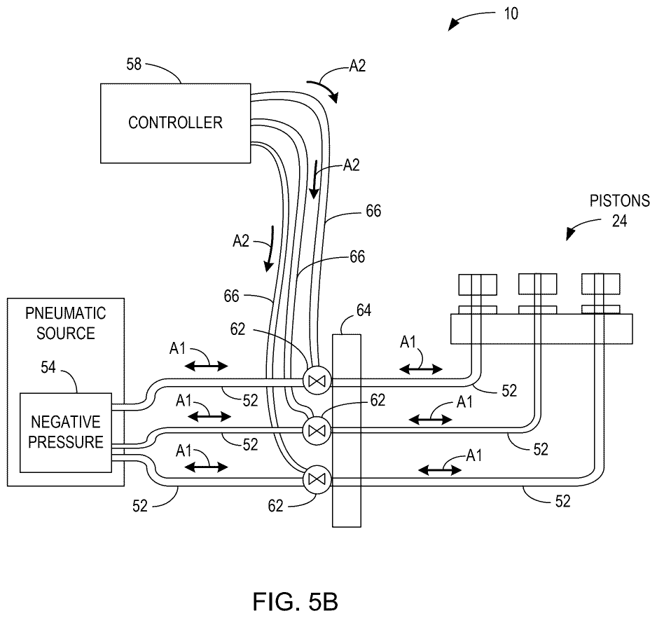

Features of the pneumatic pistons 24 are shown in FIGS. 3A and 3B, which are perspective views showing the pneumatic pistons 24 in extended and retracted positions, and in FIGS. 4A and 4B, which are schematic drawings showing electrical and mechanical components of the pneumatic pistons 24. As shown in FIGS. 3A-4B, the pneumatic pistons 24 are generally vertical supports comprising a piston head or cover 32 defining a flat or substantially (e.g., within 10% of flat) surface configured to press against a bottom surface of the slab 2 for holding the slab 2 in place. In examples, the piston head or cover 32 can be generally box-shaped with the flat top surface and four side surfaces extending downward from the top surface. In examples, the side surfaces can be positioned to enclose and protect other parts of the pneumatic pistons 24 from the water and slurry used in the cutting process thereby improving durability and preventing damage to pneumatic components and other less durable parts of the pneumatic pistons 24. In examples, the pneumatic pistons 24 can be configured to move from a retracted position (shown in FIGS. 3A and 4A) to an extended position (shown in FIGS. 3B and 4B) due to a pneumatic or hydraulic forces provided, for example, from a pneumatic pressure source 34 (shown in FIG. 5A) fluidly connected to the pneumatic pistons 24 that selectively causes one or more of the pneumatic pistons 24 to extend and retract. For example, as shown in FIGS. 2A and 2B, some pneumatic pistons 24 can be in the retracted position while other pneumatic pistons 24 are in the elevated position to support the slab 2 above the rails 18 during cutting.

In some examples, the pneumatic pistons 24 comprise a housing or base 36, such as a tubular or cylindrical housing, mounted to one or more of the rails 18 of the frame 12. The pneumatic pistons 24 further comprise a moveable support or piston member 38 at least partially disposed within the base 36 that is connected to and raises and lowers the piston head or cover 32. As shown in FIG. 1B, in some examples, platform 10 can include pneumatic pistons 24 with piston heads or covers 32 of different sizes. For example, some pistons heads or covers 32 are square-shaped full covers (e.g., having dimensions of about 8 inches by 8 inches), while other piston heads or covers 32 are rectangular half-sized covers (e.g., with dimensions of about 4 inches by 8 inches). The piston head or cover 32 sizes are selected so that the platform 10 can be used to support the slab 2 while cutting out a variety of common shapes and cutting patterns used, for example, with stone countertops for kitchens, bathrooms, or other installations. For example, the piston heads or covers 32 are smaller than common sized sink openings found in kitchen countertops so that, as described in further detail herein, pneumatic pistons 24 can be retracted to move a discardable portion of the countertop formed when cutting the sink opening away from the usable portion of the countertop. Also, as previously described, the grid of pneumatic pistons 24 is designed to be large enough to support a 5 ft. by 10 ft. stone slab. The arrangement of different sized piston heads or covers 32 gives the platform operator many options for which pneumatic pistons 24 to extend and retract, allowing for great flexibility in the types of countertop shapes that can be cut out from the common-sized stone slab 2.

As shown in FIGS. 4A and 4B, the pneumatic pistons 24 further comprise an actuator 40 for extending and retracting the piston member 38 through, for example, an open top end of the base 36. The actuator 40 can be a pneumatic actuator or device including ports or connector for receiving pressurized fluid (e.g., pressurized air or water) from the pneumatic source 34 for raising and lowering the piston member 38. For example, the pneumatic pistons 24 can comprise a positive pressure port 42 that receives positive pressure from the pneumatic source 34 for extending the pneumatic piston 24. The pneumatic piston 24 further comprises a negative pressure or suction port 44 that receives negative pressure from the pneumatic source 34 for applying suction to the bottom surface of the slab 2. In examples, the pneumatic piston 24 can also comprise a retraction port 46 that receives negative pressure from the pneumatic source 34, which is applied to the actuator 40 causing the piston member 38 of the pneumatic piston 24 to retract.

In some examples, the pneumatic piston 24 further comprises the flat or substantially flat piston head or cover 32 configured to contact the bottom surface of the slab 2. As shown in FIG. 3A-4B, the pneumatic piston 24 can also comprise a suction nozzle 48 extending through the piston head or cover 32 configured for applying suction for holding the slab 2 against the cover 32. In some examples, the pneumatic piston 24 can also be configured to apply positive pressure (e.g., a stream of pressurized air or liquid) through the suction nozzle 48 or through another nozzle (e.g., a positive pressure nozzle 50 as shown in FIGS. 3A-4B) that extends through the piston head or cover 32 for lifting the slab 2 off of the piston head or cover 32 in order to facilitate sliding the slab 2 into position and/or off of the platform 10.

In some examples, the pneumatic piston 24 can further comprise mechanical features for holding the piston member 38 in a retracted or extended position and without pneumatic pressure. For example, the pneumatic piston 24 can comprise a mechanical latch or lock for holding the piston member 38 in an extended position when, for example, the pneumatic source 34 applying positive pressure to the piston 24 is turned off. Alternatively, the pneumatic source 34 can be configured to remain on and can continue to provide positive pressure to pneumatic pistons 24 to maintain the piston members 38 in the extended position for extended periods of time, such as for an entire duration of a cutting action.

FIG. 5A is a schematic drawing showing the electronic and pneumatic components of the platform 10 and pneumatic pistons 24. As shown in FIG. 5A, the platform 10 further comprises the pneumatic source 34 fluidly connected to the pneumatic pistons 24 that selectively causes one or more of the pneumatic pistons 24 to extend or retract. In examples, the pneumatic source 34 can be, for example, a blower, fan, or vacuum pump configured for providing the positive and/or negative pressure (e.g., pressure with a force of, for example, from about 90 psi to about 100 psi or more) sufficient to extend and retract the pneumatic pistons 24 and/or to apply suction to the slab 2.

The pneumatic pistons 24 can be connected to the pneumatic source 34 via cables 52, flexible tubing, pipes, or other connectors. It is noted that for convenience and clarity, FIG. 5A shows only one pneumatic piston fluidly connected to the pneumatic source 34. However, it is understood that in order to individually and selectively operate (e.g., extend and retract) each pneumatic piston 24 of the platform 10, each pneumatic piston 24 can be independently connected to the pneumatic source 34 by multiple cables 52 or segments of flexible tubing (e.g., one cable 52 that provides negative pressure to the pneumatic piston 24 and one cable 52 that provides positive pressure to the pneumatic piston 24).

As shown in FIG. 5A, the platform 10 can include both a negative pressure source 54, such as a vacuum pump, for providing a negative pressure or suction force to the pistons 24 and a positive pressure source 56, such as a blower configured for pressurizing an air chamber or enclosure, for providing positive pressure to the pneumatic pistons 24. As previously described, the negative pressure can be applied through the suction nozzle 48 of the piston head or cover 32 for holding the bottom surface of the stone slab 2 against the piston head or cover 32. Negative pressure also retracts the piston members 38 of the pneumatic pistons 24. Positive pressure extends the piston members 38 of the pneumatic pistons 24 to the extended position. Positive pressure can also be expelled through a nozzle, such as one of the nozzles 48, 50 shown in FIGS. 3A-4B, to assist in sliding the slab 2 over and off of the platform 10.

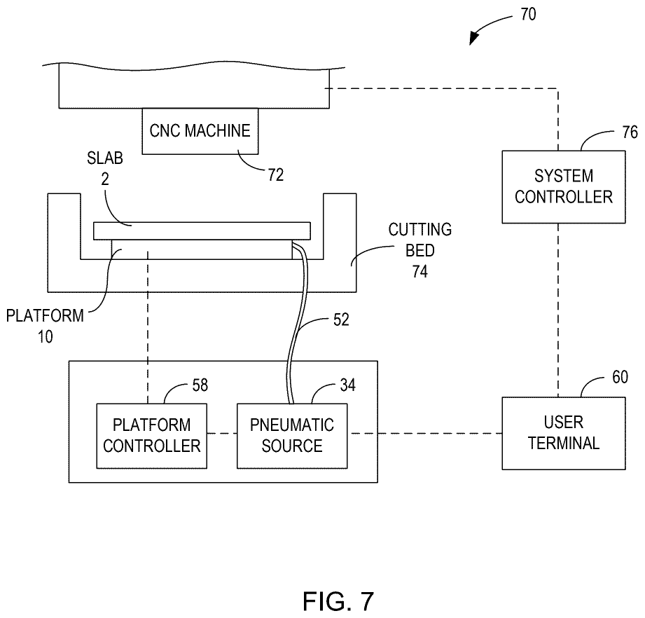

The platform 10 further comprises a controller 58 configured to selectively apply fluid pressure from the pneumatic source 34, such as the negative pressure source 54 and/or the positive pressure source 56, to one or more of the pneumatic pistons 24 for extending or retracting the pneumatic pistons 24 in coordination with automated cutting of the slab 2. The controller 58 can be a computer or computer processor associated with the pneumatic source 34. In other examples, the controller 58 can be a processor integrated or associated with the CNC machine 72. As shown in FIG. 7, the controller 58 can also be a component of a stand-alone device, such as a user terminal 60 with input buttons, a touch screen display, peripheral accessories, and/or a user interface configured to allow a user to control the platform 10 during automated cutting by the CNC machine 72.

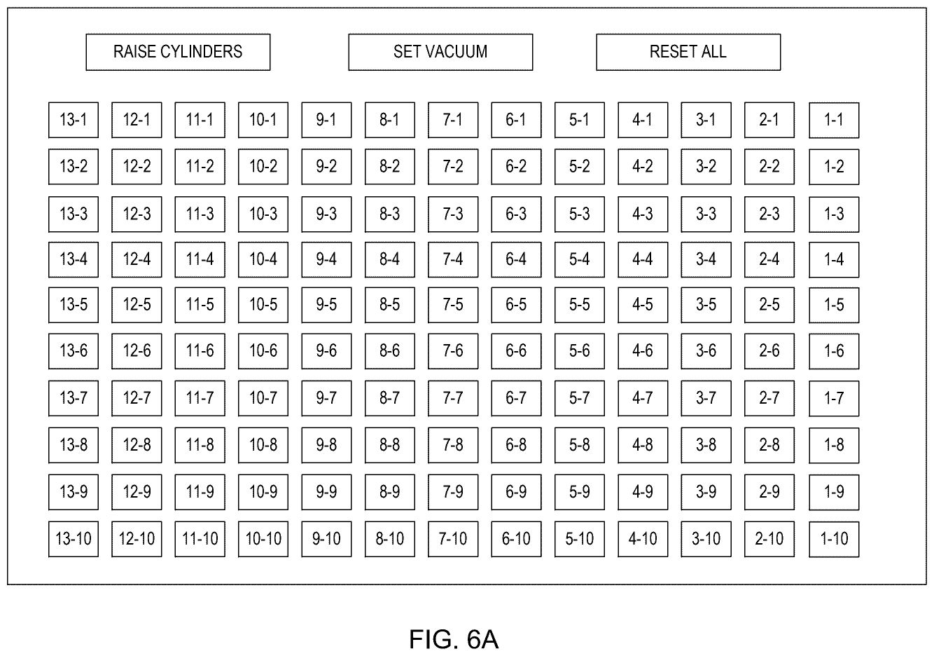

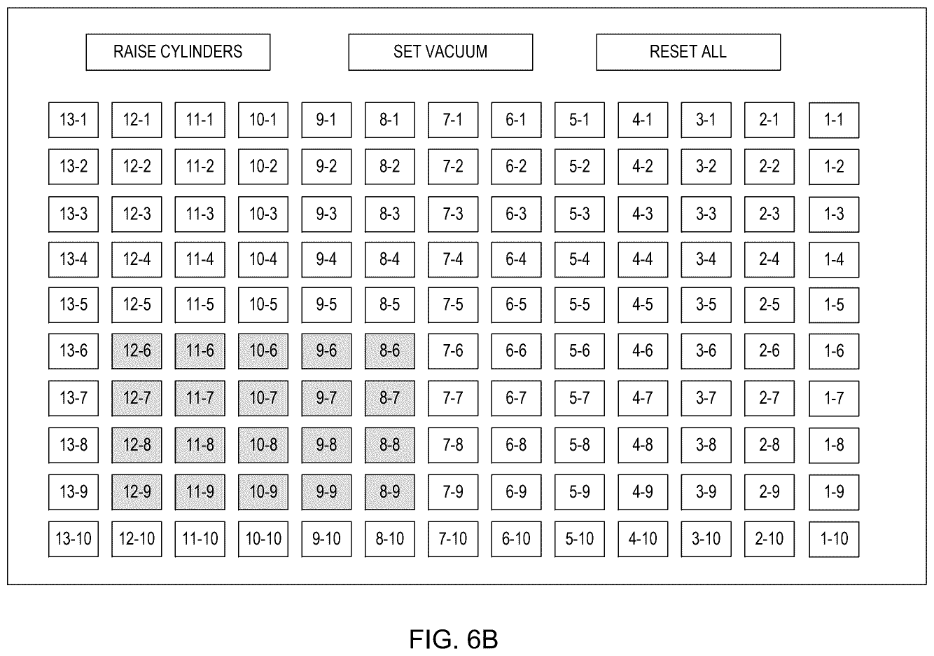

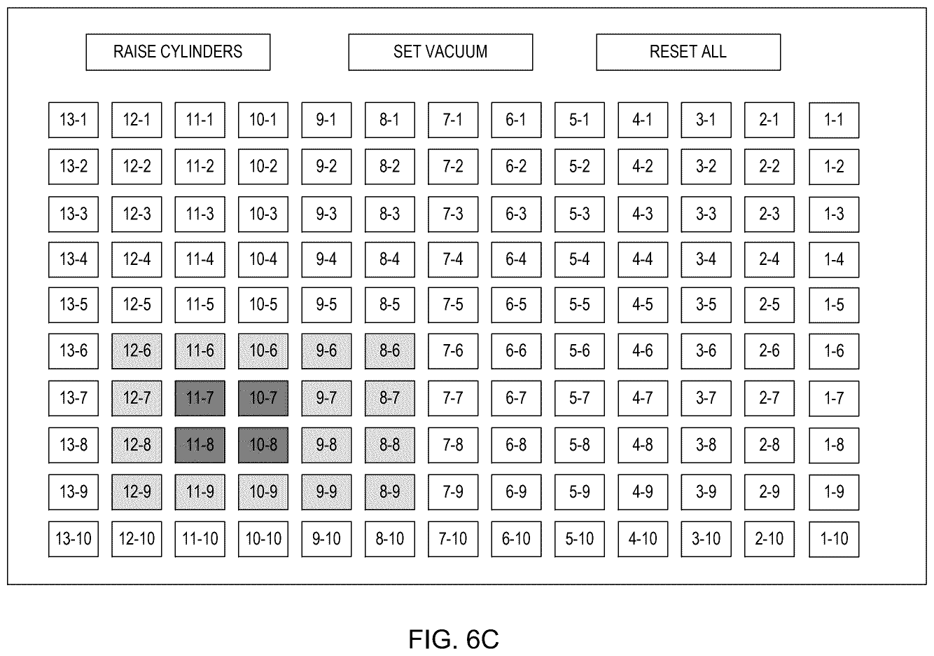

FIGS. 6A-6C are examples of screen captures for a user interface of the terminal 60 that allows a user or system operator to select and extend or retract the pneumatic pistons 24 of the platform 10 in a coordinated manner based, for example, on the shape or pattern being cut from the slab 2. As shown in FIGS. 6A-6C, each pneumatic piston 24 of the platform 10 is assigned a column number (e.g., from 1 to 13) and row number (e.g., from 1 to 10). The user interface also includes buttons for raising and lowering the pistons or cylinders and for resetting all cylinders to an initial position. As shown in FIG. 6A, all of the pistons 24 are unselected and in the retracted position. In order to cut out a portion of a slab 2, in FIG. 6B, the user selects several of the pistons 24 (e.g., pistons 12-6 through 8-9) and presses the “Raise Cylinders” button causing the selected pistons 24 to extend to lift the slab 2 away from the other pistons 24 and rails 18 of the platform 10. Once the slab 2 is raised to a desired height, cutting can be performed by the CNC machine 72. As shown in FIG. 6C, after cutting is performed, the user can select several pistons 24 (e.g., pistons 11-7, 10-7, 11-8, and 10-8) to lower so that, for example, a discardable portion of a cut slab 2 can be lowered below usable portions of the cut slab 2 allowing the usable portions of the slab 2 to be easily removed from the platform 10, while the discardable portion of the slab 2 remains in place on the retracted pneumatic pistons 24.

The controller 58 is configured to activate various valves, connections, and/or components of the pneumatic source 34 causing one or more of the pneumatic pistons 24 to extend or retract. In particular, the controller 58 can be configured to individually address and control each of the pneumatic pistons 24 causing certain valves to open or close for applying pneumatic pressure (e.g., either positive or negative pressure) to the pneumatic pistons 24. The controller 58 can also be configured to turn certain vacuum pumps, blowers, fans, or other devices on or off for applying the pneumatic forces and/or for ceasing application of pneumatic forces to the piston devices 24.

In examples, the controller 58 can also be configured to selectively cause the negative pressure source 54 to apply suction against the bottom of the slab 2 through the pneumatic pistons 24. In examples, the suction force can be applied and removed by a pneumatic activation system, which is shown schematically in FIG. 5B. As shown in FIG. 5B, the platform 10 comprises a manifold 64 of pneumatic valves 62 that are fluidly connected both to the negative pressure source 54 and to the controller 58. The valves 62 can be configured such that, when one or more of the pneumatic valves 62 is opened, suction is applied against the bottom of the slab 2 as shown by arrow A1 in FIG. 5B. When the valves 62 are closed, application of suction ceases. The pneumatic valves 62 are also fluidly connected to the controller 58 for receiving an activation signal from the controller 58. For example, the controller 58 can be configured to selectively release a fluid burst (shown by arrow A2) to one or more of the pneumatic valves 62, which causes a particular pneumatic valve 62 to open or close thereby exposing the slab 2 to suction or removing the suction so that the slab 2 can slide over the platform 10.

In examples, the platform 10 comprises one pneumatic valve 62 for each piston 24 of the platform 10. For example, a platform 10 with one hundred and thirty (130) pneumatic pistons 24 comprises one hundred and thirty (130) pneumatic valves 62. The valves 62 can be mounted, for example, to a support, such as a board or metal sheet, forming the valve manifold 64 supporting the pneumatic valves 62. As shown in FIG. 5B, there are cables 66 extending from the controller 58 to each valve 62, for supplying the fluidic bursts that open or close the valves 62. As previously described, there are also cables 52 extending from the negative pressure source 54 to each valve 62 and from each valve 62 to one of the pneumatic pistons 24 for applying the suction force to each pneumatic piston 24.

In some examples, as shown in FIG. 7, the platform 10 can be integrated into an automated cutting system 70, including a computer-controlled cutting or CNC machine 72. The integrated or computer-controlled system 70 for automated cutting of a stone slab 2 can include the horizonal lathe or cutting bed 74 and the CNC machine 72 over the cutting bed 74 configured for cutting the stone slab 2 to a desired shape. For example, as previously described, the CNC machine 72 can be suspended above the cutting bed 74 on a track or mechanical arm and moved into position for making various cuts by motors, gears, and similar mechanical devices, as are known in the art.

As shown in FIG. 7, the system 70 also comprises the platform 10 resting on or mounted to the cutting bed 74 for supporting the stone slab 2. In particular, the first and second base members 14, 16 of the platform 10 can be positioned on and/or affixed to the cutting bed 74 ensuring that the platform 10 remains stable when supporting the stone slab 2. As in previous examples, the platform 10 also includes the rails 18 extending between the base members 14, 16 and the pneumatic pistons 24 mounted to the rails 18 and arranged in columns and rows to form a grid of piston devices 24 for supporting the slab 2.

In examples, the computer-controlled cutting machine 72 cuts the slab 2 under water to avoid creation of dust and other airborne particles, which can occur with other cutting methods, and which should be mitigated through use of extensive ventilation systems. Also, cutting the slab 2 under water can avoid cracking due to applied heat and/or aggressive mechanical forces from other cutting methods. In examples, the CNC machine 72 can be a water jet cutter that applies a slurry stream consistent of water and abrasive particles for precisely cutting the slab 2 according to a predetermined cutting pattern. The abrasive material of the cutting slurry can damage devices and mechanical parts in the cutting bed 74. Therefore, as previously described, the pistons 24 of the platform 10 are simple hydraulic or pneumatic pistons that only extend and retract. The pistons 24 do not include gears or other mechanical features for moving the piston member 34 between the retracted and extended positions. Also, the pistons 24 do not include mechanical features for moving the pistons 24 across or to other positions on the cutting bed 74, as occurs with other positioning devices and systems. It is believed that such mechanisms and mechanical features may be damaged by the slurry limiting the useful life of such systems or requiring frequent repairs to address damage caused by the slurry. By contrast, the platform 10 with the pistons 24 that move only in one direction (e.g., between the retracted position and the extended position) is believed to be more durable and less susceptible to damage from the slurry and other forces exerted on the cutting bed 74 by the cutting machine 72.

In examples, the system 70 can further comprise a system controller 76 integrated and/or in communication with the CNC machine 72, platform controller 58, and/or pneumatic source 34. The system controller 76 can be configured to activate and control the CNC machine 72 for cutting the stone slab 2 according to a predetermined pattern and/or as controlled by a system operator. The system controller 76 can also be configured to control the pneumatic source 30 and/or platform controller 52 in order to extend or retract the pneumatic pistons 24 as the stone slab 2 is being cut and shaped.

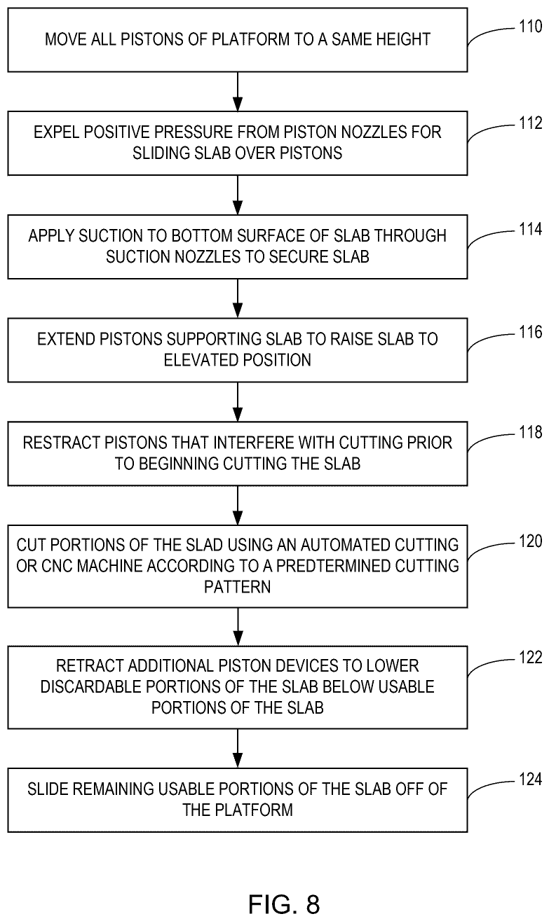

FIG. 8 is a flow chart showing a method for using the platform 10 during automated cutting of a stone slab 2 using a computer-controlled cutting device, such as the CNC machine 72. As shown in FIG. 8, the method includes a step 110 of moving all pistons 24 of the platform 10 to the same vertical height. In other examples, all of the pneumatic pistons 24 can be moved to the extended position or to an intermediate position between the extended position and the retracted position. Once the pistons 24 are at a same vertical height, at step 112, the method can comprise causing the pneumatic source 34 to expel positive pressure from some or all of the pistons 24 to facilitate sliding the slab 2 over the piston heads or covers 32 of the pistons 24. For example, the method can comprise causing positive pressure from the pressure source 34 to be expelled from the nozzles 48, 50 that extend through the piston head or cover 32 of the pneumatic pistons 24. The method then includes moving the slab 2 over the piston covers 32 to a desired position on the platform 10. For example, as shown in FIGS. 9A and 9B, a slab 2 or portions of a slab 2 can be positioned on the platform 10 such that edges of the slab 2 contact the stops 30, thereby ensuring that a zero position for the slab 2 is known.

Once the slab 2 is on the pneumatic pistons 24, at step 114, the method comprises applying suction to the bottom surface of the slab 2 through the suction nozzle 48 that extends through the piston head or cover 32. For example, as previously described, the platform controller 58 can be configured to apply fluid bursts to one or more of the pneumatic valves 62 of the manifold 64 causing the valves 62 to transition from a closed position to an open position. When the pneumatic valves 62 are open, the negative pressure or suction is applied from the pneumatic source 34 through the nozzle 48 of one or more of the pistons 24 to the bottom surface of the slab 2. The negative pressure or suction secures the slab 2 against the top surface of the piston head or cover 32, preventing the slab 2 from moving during cutting.

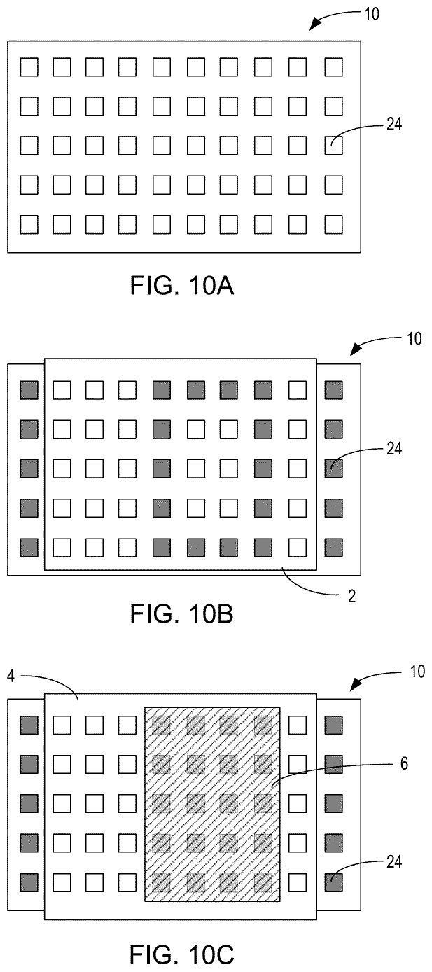

Next, at step 116, the method can include extending any pistons 24 that support the slab 2, thereby moving the slab 2 to an extended or elevated position convenient for cutting. For example, as shown in FIG. 10A, all of the pneumatic pistons 24 can be moved to the extended position, as shown by the unfilled squares in FIG. 10A. Next, at step 118, the method further comprises retracting some of the pneumatic pistons 24, as shown by the filled squares in FIG. 10B, so that the pistons 24 do not interfere with the cutting pattern for the stone slab 2.

At step 120, with the slab 2 held in position on the piston heads or covers 32 by suction, the method further comprises cutting portions of the slab 2 using the automated cutting or CNC machine 72 according to a predetermined cutting pattern. In particular, as shown in FIG. 10C, the predetermined cutting pattern can create usable portions 4 of the slab 2, such as portions of the slab 2 used to make countertops, shelves, or other decorative surfaces. The cutting pattern can also create scrap or discardable portions 6, such as portions of the slab 2 that are cut out to form openings for sinks, faucets, stoves, and other appliances.

In some examples, after cutting is performed, at step 122, the method can further comprise retracting additional pistons 24 to lower the discardable portions 6 of the slab 2 below the usable portions 4 of the slab 2, as shown by the additional filled squares in FIG. 10C. For example, when cutting a hole or opening in the slab 2, such as an opening for a sink in a countertop, into the pistons 24 supporting the discardable portions 6 (e.g., the sink opening) can be lowered relative to the usable portions 4 of the countertop.

At step 124, with the discardable portions 6 of the countertop lowered or removed, the method further comprises sliding the remaining usable portions 4 of the slab 2 off of the platform 10. As previously described, in some examples, positive pressure can be expelled from positive pressure ports 50 of the piston heads or covers 28 to facilitate sliding or moving portions of the stone slab 2 off of the platform 10.

It is to be understood that the invention may assume various alternative variations, except where expressly specified to the contrary. It is also to be understood that the specific devices illustrated in the attached drawings, and described in the specification, are simply exemplary embodiments of the invention. Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope thereof. For example, it is to be understood that the present invention contemplates that, to the extent possible, one or more features of any embodiment can be combined with one or more features of any other embodiment. The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

The invention claimed is

1. A platform for supporting a slab during automated cutting, the platform comprising:
a frame for supporting the slab in a substantially horizontal position over a cutting bed, the frame comprising a plurality of rails configured to extend over the cutting bed;
a plurality of pneumatic pistons mounted to the plurality of rails and arranged to form a grid arranged in rows and columns of pneumatic pistons for supporting the slab over the cutting bed;
at least one pneumatic source fluidly connected to the plurality of pneumatic pistons that selectively causes one or more of the plurality of pneumatic pistons to extend and retract; and
a controller configured to selectively apply fluid pressure from the at least one pneumatic source to the one or more of the plurality of pneumatic pistons for extending or retracting the plurality of pneumatic pistons in coordination with automated cutting of the slab.

2. The platform of claim 1, wherein the slab weighs about 10 to 20 pounds per square foot with a total weight of 500 pounds to 1000 pounds.

3. The platform of claim 1, further comprising one or more elongated base supports configured to extend over the cutting bed and below the plurality of rails, wherein the plurality of rails are fixed to the one or more elongated base supports for maintaining positioning of the plurality of rails and the plurality of pneumatic pistons on the cutting bed.

4. The platform of claim 1, wherein the plurality of pneumatic pistons are mounted to the plurality of rails and arranged to form about 5 rows to 15 rows of pistons.

5. The platform of claim 1, wherein the frame is about 100 inches to about 150 inches in length and about 25 inches to about 100 inches in width.

6. The platform of claim 1, wherein the frame comprises about twelve (12) rails and the plurality of pneumatic pistons are arranged to form ten (10) rows, thereby providing a grid of thirteen (13) columns and ten (10) rows of the pneumatic pistons.

7. The platform of claim 1, wherein at least one rail of the plurality of rails comprises a track extending longitudinally on a top surface of the at least one rail and rotatable wheels mounted in the track for sliding the slab over the plurality of pneumatic pistons when the plurality of pneumatic pistons are retracted.

8. The platform of claim 1, wherein one or more pistons of the plurality of pneumatic pistons comprises:
a base mounted to one or more of the plurality of rails of the frame;
a piston member at least partially disposed within the base; and
a pneumatic actuator for extending and retracting the piston member.

9. The platform of claim 8, wherein the one or more pistons further comprises a cover over a distal end of the piston member configured to contact and support a bottom surface of the slab, and
wherein the one or more pistons comprises at least one nozzle extending through the cover configured for applying suction for holding the slab against the cover.

10. The platform of claim 9, wherein the at least one nozzle is a suction nozzle configured to apply suction for holding the slab against the cover, the one or more pistons further comprising a separate nozzle for applying positive pressure to the bottom surface of the slab for separating the bottom surface of the slab from the cover.

11. The platform of claim 1, wherein the at least one pneumatic source comprises a negative pressure source for applying suction against a bottom surface of the slab and a positive pressure source for extending the plurality of pneumatic pistons and for lifting the slab off of a cover of the plurality of pneumatic pistons for sliding the slab over the plurality of pneumatic pistons.

12. The platform of claim 11, wherein the one or more of the plurality of pneumatic pistons comprises at least one positive pressure port that receives positive pressure from the at least one pneumatic source for extending the one or more pistons and at least one negative pressure port that receives negative pressure from the at least one pneumatic source for applying suction to the bottom surface of the slab.

13. The platform of claim 11, wherein the controller is configured to selectively cause the negative pressure source to apply suction against the bottom surface of the slab through one or more pistons of the plurality of pneumatic pistons by actuating one or more pneumatic valves.

14. The platform of claim 13, wherein the one or more pneumatic valves are fluidly connected between the negative pressure source and the one or more pistons, such that when the one or more pneumatic valves are opened, the suction is applied against the bottom surface of the slab and when the one or more pneumatic valves are closed, application of suction ceases.

15. The platform of claim 14, wherein the one or more pneumatic valves are fluidly connected to the controller and wherein the controller selectively releases a fluid burst to the one or more pneumatic valves causing the one or more pneumatic valves to open or close.

16. The platform of claim 1, further comprising at least one retractable stop positioned at a periphery of the grid of the plurality of pneumatic pistons, the at least one retractable stop configured to move between a retracted position allowing the slab to slide over the at least one retractable stop and onto the plurality of pneumatic pistons and an extended position where an edge of the slab contacts the at least one retractable stop for positioning the slab on the grid formed by the plurality of pneumatic pistons.

17. The platform of claim 1, wherein the controller comprises a user terminal comprising input buttons, a touch screen display, and/or a user interface allowing a user to selectively extend and retract one or more pistons of the plurality of pneumatic pistons.

18. A computer-controlled system for automated cutting of a stone slab, comprising:
a cutting bed;
a computer-controlled cutting machine over the cutting bed configured for cutting the stone slab to a desired shape;
the platform of claim 1 positioned on the cutting bed for supporting the stone slab during cutting; and
a system controller in communication with the computer-controlled cutting machine and with the controller of the platform for coordinating extension and retraction of the plurality of pneumatic pistons of the platform and cutting actions of the computer-controlled cutting machine.

19. A method of cutting a stone slab, comprising:
moving some or all of the plurality of pneumatic pistons of the platform of claim 1 to a same height;
moving the slab over some or all of the plurality of pneumatic pistons to a desired position on the grid formed by the plurality of pneumatic pistons;
with the slab in place at the desired position, applying suction against a bottom surface of the slab through nozzles of some or all of the plurality of retractable piston devices; and
cutting portions of the slab using an automated cutting machine according to a predetermined cutting pattern.

20. The method of claim 19, further comprising, after cutting is performed, retracting some of the plurality of pneumatic pistons to recess discardable portions of the slab and, after discardable portions of the slab are recessed, sliding a remaining usable portion of the slab off of the platform.
